(19) United States
(12) Patent Application Publication
(10) Pub. No.: US 2011/0293844 A1
(43) Pub. Date: Dec. 1, 2011

(54) PAINT COMPOSITION AND COATING FILM FORMATION METHOD

(76) Inventors: Remi Kasai, Kanagawa (JP); Toshiyuki Hanaoka, Kanagawa (JP); Toshiaki Nagano, Kanagawa (JP); Hiromi Harakawa, Kanagawa (JP)

(21) Appl. No.: 13/147,682

(22) PCT Filed: Feb. 18, 2010
(86) PCT No.: PCT/JP2010/052470

§ 371 Date: Aug. 3, 2011

(30) Foreign Application Priority Data
Feb. 23, 2009 (JP) 2009-039161

(51) Int. Cl. C09D 133/14; B05D 1/36; C09D 169/00

(52) U.S. Cl. 427/407.1; 524/502

(57) ABSTRACT

An object of the present invention is to provide a coating composition capable of forming a cured coating film with excellent scratch resistance, acid resistance, stain resistance, and finished appearance.

The present invention provides coating composition comprising (A) carboxy-containing polymer, (B) epoxy-containing acrylic resin, and (C) carboxy-containing reaction product with an acid value of 50 to 200 mg KOH/g and a number average molecular weight of 600 to 5,000 obtained by a half-esterification reaction of an acid anhydride with a polycarbonate polyol having three or more hydroxyl groups per molecule.

### TECHNICAL FIELD

The present invention relates to a novel coating composition having excellent coating film performance in terms of scratch resistance, acid resistance, and stain resistance.

### BACKGROUND ART

Coating compositions that are applied to automobile bodies or like coated objects are required to provide excellent coating film performance in terms of scratch resistance, acid resistance, stain resistance, finished appearance, etc.

Hitherto, melamine crosslinking coating compositions have been widely used as coating compositions for such objects to be coated. The melamine crosslinking coating composition is a coating composition containing a hydroxy-containing resin, and a melamine resin as a cross-linking agent. The melamine crosslinking coating composition has a high crosslinking density during heat curing, and the coating film formed therefrom has excellent coating film performance in terms of scratch resistance, finished appearance, etc. However, the melamine crosslinkage in this coating composition easily undergoes hydrolysis by acid rain; therefore, this coating composition provides unsatisfactory acid resistance.

Patent Literature 1 disclose, as a top clear coating composition for automobiles, a coating composition comprising a polyepoxide such as an epoxy-containing acrylic polymer, and a polyacid curing agent such as a carboxy-containing acrylic polymer or a carboxy-containing polyester. Patent Literature 1 also states that the epoxy-containing acrylic polymer may have a silane functional group. Coating films formed from this coating composition have improved acid resistance because melamine resins are not used; however, such coating films have insufficient scratch resistance.

Patent Literature 2 discloses, as a topcoat composition for automobiles, a coating composition comprising an epoxy- and hydroxy-containing compound, and a copolymer of an acid anhydride group-containing monomer and other monomers, in which the acid anhydride group is half-esterified. However, coating films formed from the coating composition also have insufficient scratch resistance, although they have improved acid resistance.

Additionally, Patent Literature 3 discloses, as a top clear coating composition suitable for automobile bodies and the like, a coating composition comprising a hydroxy- and epoxy-containing acrylic resin, a high-acid-value polyester resin, an alkoxysilyl-containing acrylic resin, and an acrylic resin containing a dimethylsiloxane side chain. However, coating films formed from the coating composition still have insufficient scratch resistance, although they have improved acid resistance.

### CITATION LIST

### Patent Literature

PTL 1: Japanese Unexamined Patent Publication No. S62-87288
PTL 2: Japanese Unexamined Patent Publication No. H3-287650
PTL 3: Japanese Unexamined Patent Publication No. 2003-89764

### SUMMARY OF INVENTION

### Technical Problem

An object of the present invention is to provide a coating composition capable of forming a cured coating film with excellent scratch resistance, acid resistance, stain resistance, and finished appearance.

### Solution to Problem

The present inventors conducted extensive research to achieve the above object, and as a result, found that the above object can be achieved by a coating composition comprising a carboxy-containing polymer, an epoxy-containing acrylic resin, and a carboxy-containing reaction product with an acid value and a number average molecular weight in specific ranges obtained by a half-esterification reaction of an acid anhydride with a polycarbonate polyol having three or more hydroxyl groups per molecule. The present invention has been accomplished based on the above finding.

Specifically, the present invention provides the following coating composition, and a method for forming a multilayer coating film:

Item 1. A coating composition comprising (A) a carboxy-containing polymer, (B) an epoxy-containing acrylic resin, and (C) a carboxy-containing reaction product with an acid value of 50 to 200 mg KOH/g and a number average molecular weight of 600 to 5,000 obtained by a half-esterification reaction of an acid anhydride with a polycarbonate polyol having three or more hydroxyl groups per molecule.

Item 2. The coating composition according to Item 1, wherein the acid anhydride is at least one kind selected from the group consisting of succinic anhydride, hexahydrophthalic anhydride, and trimellitic anhydride.

Item 3. The coating composition according to Item 1 or 2, wherein the epoxy-containing acrylic resin (B) is an epoxy- and alkoxysilyl-containing acrylic resin.

Item 4. The coating composition according to any one of Items 1 to 3, wherein the proportions of the carboxy-containing polymer (A), epoxy-containing acrylic resin (B), and carboxy-containing reaction product (C) are such that the equivalent ratio of carboxy groups in the components (A) and (C) to epoxy groups in the component (B) is 1:0.5 to 0.5:1, and

the proportions of the carboxy-containing polymer (A) and carboxy-containing reaction (C) are such that, on a solids basis, the component (A) is 20 to 90 mass %, and the component (C) is 10 to 80 mass %, relative to the total amount of the components (A) and (C), and the proportion of the carboxy-containing reaction product (C) is, on a solids basis, 3 to 40 mass %, relative to the total amount of the carboxy-containing polymer (A), epoxy-containing acrylic resin (B), and reaction product (C).

Item 5. A method for forming a multilayer coating film, the method comprising forming, on a substrate, one or two colored base coating layers and one or two clear coating layers, wherein an uppermost clear coating layer is formed using the coating composition according to any one of Items 1 to 4.

### Advantageous Effects of Invention

The coating composition of the present invention is capable of forming a coating film with excellent finished appearance such as gloss and smoothness because the carboxy-containing reaction product (C) with an acid value of 50 to 200 mg KOH/g and a number average molecular weight of 600 to 5,000 obtained by a half-esterification reaction of an acid anhydride with a polycarbonate polyol having three or more hydroxyl groups per molecule has good compatibility with the carboxy-containing polymer (A) and epoxy-containing acrylic resin (B).

The coating composition of the present invention is also capable of forming a cured coating film with excellent scratch resistance, acid resistance, stain resistance, etc., because of the following reasons: the reaction product (C) improves the physical properties, such as mechanical strength, of the coating film; and the crosslinkages formed by the reaction of the reaction product (C) and carboxy-containing polymer (A) with the epoxy-containing acrylic resin (B), and the carbonate linkages of the reaction product (C) both have excellent hydrolysis resistance. Further, the coating film formed using the coating composition of the present invention maintains high coating film performance in terms of scratch resistance, acid resistance, stain resistance, etc., for a long time.

As described above, the coating composition of the present invention achieves the effect of forming a coating film with excellent coating film performance in terms of scratch resistance, acid resistance, stain resistance, gloss, smoothness, etc.

### DESCRIPTION OF EMBODIMENTS

Hereinbelow, the coating composition (hereinafter sometimes referred to as “the present coating composition”) and method for forming a multilayer coating film of the present invention are described in detail.

Coating Composition

The coating composition of the present invention comprises a carboxy-containing polymer (A), an epoxy-containing acrylic resin (B), and a specific carboxy-containing reaction product (C).

Carboxy-Containing Polymer (A)

The carboxy-containing polymer (A) encompasses known carboxy-containing polymers other than the reaction product (C). Preferable examples of the carboxy-containing polymer (A) include a vinyl polymer (A-1) containing half-esterified acid anhydride group or groups, and a carboxy-containing polyester polymer (A-2).

Half-Esterified Acid Anhydride Group-Containing Vinyl Polymer (A-1)

The term “half-esterified acid anhydride group” as used herein means a group comprising carboxy and carboxylate groups, which is obtained by adding an aliphatic monohydric alcohol to an acid anhydride group to perform ring opening (i.e., half-esterification). The half-esterified acid anhydride group is hereinafter sometimes referred to simply as “half ester group”.

The polymer (A-1) can be easily obtained by, for example, copolymerizing a half ester group-containing vinyl monomer with other vinyl monomers by a standard method. The polymer (A-1) can also be easily obtained by carrying out copolymerization in a similar manner using an acid anhydride group-containing vinyl monomer in place of the half ester group-containing vinyl monomer, and then half-esterifying the acid anhydrous group. The polymer (A-1) can also be obtained by carrying out copolymerization in a similar manner using a hydroxy-containing vinyl monomer in place of the half ester group-containing vinyl monomer, and then half-esterifying the hydroxy group.

Examples of half ester group-containing vinyl monomers include compounds obtained by half-esterifying acid anhydride groups of acid anhydride group-containing vinyl monomers; compounds obtained by adding acid anhydrides to hydroxy-containing vinyl monomers by half-esterification; etc.

Specific examples of compounds obtained by half-esterifying acid anhydride groups of acid anhydride group-containing vinyl monomers include monoesters of acid anhydride group-containing vinyl monomers, such as maleic anhydride, itaconic anhydride, etc., with aliphatic monoalcohols; and the like.

Specific examples of compounds obtained by adding acid anhydrides to hydroxy-containing vinyl monomers by half-esterification include compounds obtained by adding, by half-esterification, acid anhydrides, such as phthalic anhydride, hexahydrophthalic anhydride, etc., to hydroxy-containing vinyl monomers mentioned hereinafter as other vinyl monomers.

As mentioned above, the half-esterification can be carried out either before or after the copolymerization reaction. Examples of aliphatic monohydric alcohols that can be used for the half-esterification include low-molecular-weight monohydric alcohols, such as methanol, ethanol, isopropanol, tert-butanol, isobutanol, ethylene glycol monomethyl ether, ethylene glycol monoethyl ether, etc. The half-esterification reaction can be carried out by a usual method, at room temperature to about 80° C., using, if necessary, a basic catalyst such as a tertiary amine.

Examples of other vinyl monomers mentioned above include hydroxy-containing vinyl monomers; (meth)acrylic acid esters; vinyl ethers and allyl ethers; olefinic compounds and diene compounds; nitrogen-containing unsaturated monomers; styrene, α-methylstyrene, vinyltoluene; etc.

Examples of hydroxy-containing vinyl monomers include C₂₋₈ hydroxyalkyl esters of acrylic or methacrylic acid, such as 2-hydroxyethyl(meth)acrylate, 3-hydroxypropyl(meth)acrylate, 4-hydroxybutyl(meth)acrylate, etc.; monoesters of polyether polyols, such as polyethylene glycol, polypropylene glycol, polybutylene glycol, etc., with unsaturated carboxylic acids, such as (meth)acrylic acid and the like; monoethers of polyether polyols, such as polyethylene glycol, polypropylene glycol, polybutylene glycol, etc., with hydroxy-containing unsaturated monomers, such as 2-hydroxyethyl(meth)acrylate and the like; diesters of acid anhydride group-containing unsaturated compounds, such as maleic anhydride, itaconic anhydride, etc., with glycol compounds, such as ethylene glycol, 1,6-hexanediol, neopentyl glycol, etc.; hydroxyalkyl vinyl ethers compounds such as hydroxyethyl vinyl ether and the like; allyl alcohol and the like; 2-hydroxypropyl(meth)acrylate; adducts of α,β-unsaturated carboxylic acids with monoepoxy compounds such as “Cardula E10” (tradename of Shell Petrochemical Co., Ltd.), α-olefin epoxide, etc; adducts of glycidyl(meth)acrylate with monobasic acids such as acetic acid, propionic acid, p-tert-butylbenzoic acid, aliphatic acids compounds, etc.; adducts of the above hydroxy-containing monomers with lactone compounds (e.g., ε-caprolactone, γ-valerolactone); and the like.

As used herein, “(meth)acrylate” means “acrylate or methacrylate”; “(meth)acrylic acid” means “acrylic acid or methacrylic acid”; and “(meth)acrylamide” means “acrylamide or methacrylamide”.

Examples of (meth)acrylic acid esters include C₁₋₂₄ alkyl esters or cycloalkyl esters of acrylic or methacrylic acid, such as methyl acrylate, ethyl acrylate, propyl acrylate, isopropyl acrylate, n-butyl acrylate, isobutyl acrylate, tert-butyl acrylate, hexyl acrylate, 2-ethylhexyl acrylate, n-octyl acrylate, decyl acrylate, stearyl acrylate, lauryl acrylate, cyclohexyl acrylate, methyl methacrylate, ethyl methacrylate, n-propyl methacrylate, isopropyl methacrylate, n-butyl methacrylate, isobutyl methacrylate, tert-butyl methacrylate, hexyl methacrylate, 2-ethylhexyl methacrylate, octyl methacrylate, decyl methacrylate, lauryl methacrylate, stearyl methacrylate, etc.; C₂₋₁₈ alkoxyalkyl esters of acrylic or methacrylic acid, such as methoxybutyl acrylate, methoxybutyl methacrylate, methoxyethyl acrylate, methoxyethyl methacrylate, ethoxybutyl acrylate, ethoxybutyl methacrylate, etc.; and the like.

Examples of vinyl ethers and allyl ethers include ethyl vinyl ether, n-propyl vinyl ether, isopropyl vinyl ether, butyl vinyl ether, tert-butyl vinyl ether, pentyl vinyl ether, hexyl vinyl ether, octyl vinyl ether, and like linear or branched alkyl vinyl ether compounds; cyclopentyl vinyl ether, cyclohexyl vinyl ether, and like cycloalkyl vinyl ether compounds; phenyl vinyl ether, and like aryl vinyl ether compounds; benzyl vinyl ether, phenethyl vinyl ether, and like aralkyl vinyl ether compounds; allyl glycidyl ether, allyl ethyl ether, and like allyl ether compounds; etc.

Examples of olefin compounds and diene compounds include ethylene, propylene, butylene, vinyl chloride, butadiene, isoprene, chloroprene, etc.

Examples of nitrogen-containing unsaturated monomers include N,N-dimethylaminoethyl(meth)acrylate, N,N-diethylaminoethyl (meth)acrylate, N-tert-butylaminoethyl (meth)acrylate, and like nitrogen-containing alkyl (meth)acrylates; acrylamide, methacrylamide, N-methyl (meth)acrylamide, N-ethyl(meth)acrylamide, N,N-dimethyl (meth) acrylamide, N,N-dimethylaminopropyl(meth) acrylamide, N,N-dimethylaminoethyl (meth)acrylamide, and like polymerizable amide compounds; 2-vinylpyridine, 1-vinyl-2-pyrrolidone, 4-vinylpyridine, and like aromatic nitrogen-containing monomers; acrylonitrile, methacrylonitrile, and like polymerizable nitriles; allylamines; etc.

Mixtures of various monomers as mentioned above can be copolymerized by a generally employed method for copolymerizing vinyl monomers; however, considering the versatility, cost, etc., solution radical polymerization in an organic solvent is preferable. When solution radical polymerization is employed, a desired copolymer can be easily obtained by carrying out a copolymerization reaction of a monomer mixture at about 60 to 165° C. in an organic solvent in the presence of a polymerization initiator. Examples of the organic solvent include xylene, toluene, and like aromatic solvents; methyl ethyl ketone, methyl isobutyl ketone, and like ketone solvents; ethyl acetate, butyl acetate, isobutyl acetate, 3-methoxy butyl acetate, and like ester solvents; n-butanol, isopropyl alcohol, and like alcohol solvents; etc. Examples of the polymerization initiator include azobisisobutyronitrile, benzoyl peroxide, etc.

The suitable proportions of the half ester group- or acid anhydride group-containing vinyl monomer and other vinyl monomers used in the copolymerization, relative to the total amount of monomers used, are usually as follows: the proportion of the half ester group- or acid anhydride group-containing vinyl monomer is preferably about 5 to 40 mass %, and more preferably about 10 to 30 mass %, from the viewpoint of the balance between the curing reactivity and storage stability of the resulting copolymer.

The proportion of other vinyl monomers is preferably about 60 to 95 mass %, and more preferably about 70 to 90 mass %. When an acid anhydride group-containing vinyl monomer is used, a half-esterification reaction is carried out after the copolymerization reaction, as described above.

To achieve an excellent compatibility of the polymer (A-1) with the epoxy-containing acrylic resin (B) and reaction product (C), and to obtain a coating film with excellent gloss, acid resistance, etc., from the coating composition containing the polymer (A-1), the polymer (A-1) is preferably an acrylic polymer having a number average molecular weight in the range of about 1,000 to 10,000, and more preferably about 1,200 to 7,000, and an acid value in the range of about 50 to 250 mg KOH/g, and more preferably about 100 to 200 mg KOH/g.

As used herein, the number average molecular weight of resin was measured by GPC (gel permeation chromatography) using polystyrene standards. The number average molecular weights shown in the Production Examples and elsewhere, were measured using a GPC apparatus “HLC8120GPC” (tradename of TOSOH CORP.) and four columns “TSKgel G-4000HXL”, “TSKgel G-3000HXL”, “TSKgel G-2500HXL”, and “TSKgel G-2000HXL” (all tradenames of TOSOH CORP.), under the following conditions. Mobile phase: tetrahydrofuran; measurement temperature: 40° C.; flow rate: 1 cc/min; detector: R1.

Carboxy-Containing Polyester Polymer (A-2)

The number average molecular weight of the polymer (A-2) is not limited, but it is usually preferable that the number average molecular weight be in the range of about 500 to 10,000, and more preferably about 800 to 5,000, to obtain a coating film with excellent gloss, acid resistance, etc., from the coating composition containing the polymer (A-2).

The carboxy-containing polyester polymer can be easily obtained by a condensation reaction of a polyhydric alcohol with a polycarboxylic acid. For example, the carboxy-containing polyester polymer can be obtained by a one-step reaction under such conditions that carboxy groups of the polycarboxylic acid are present in excess. Alternatively, the carboxy-containing polyester polymer can be obtained by first synthesizing a hydroxy-terminated polyester polymer under such conditions that hydroxy groups of the polyhydric alcohol are present in excess, and thereafter adding an acid anhydride-containing compound.

Examples of the polyhydric alcohol include ethylene glycol, butylene glycol, 1,6-hexanediol, 2-butyl-2-ethyl-1,3-propanediol, 3-methyl-1,5-pentanediol, trimethylolpropane, pentaerythritol, etc. Examples of polycarboxylic acids include adipic acid, terephthalic acid, isophthalic acid, phthalic anhydride, hexahydrophthalic anhydride, etc. Examples of acid anhydride group-containing compounds include phthalic anhydride, hexahydrophthalic anhydride, succinic anhydride, etc.

To improve the compatibility of the carboxy-containing polyester polymer (A-2) with the epoxy-containing acrylic resin (B) and reaction product (C) and to obtain a coating film with improved adhesion from the coating composition containing the polymer (A-2), hydroxy groups can be introduced into the polymer (A-2) to such an extent that the polymer (A-2) has a hydroxy value in the range of about 100 mg KOH/g or less. When the conditions are such that carboxy groups are present in excess, hydroxy groups can be introduced by, for example, terminating the condensation reaction during the course thereof; and when the conditions are such that hydroxy groups are present in excess, hydroxy groups can be easily introduced by first synthesizing a hydroxy-terminated polyester polymer and then adding an acid anhydride group-containing compound so that the amount of acid groups is smaller than that of hydroxy groups.

A particularly preferable example of the carboxy-containing polyester polymer is the following carboxy-containing, high-acid-value polyester. The term “high-acid-value polymer” as used herein usually means a polymer with an acid value of more than 70 mg KOH/g.

The carboxy-containing, high-acid-value polyester can be easily obtained by performing an esterification reaction of a polyhydric alcohol with a polycarboxylic acid or a lower alkyl ester thereof, under such conditions that the amount of hydroxy groups is in excess of the amount of carboxy groups, to obtain a polyester polyol, which is then subjected to a half-esterification reaction with an acid anhydride group-containing compound. The carboxy group encompasses acid anhydride groups, and, when calculating the amount of carboxy groups, 1 mol of acid anhydride groups is counted as 2 mol of carboxy groups. The esterification reaction may be either a condensation reaction or transesterification reaction.

The above polyester polyol can be obtained under usual esterification reaction conditions. It is preferable that the polyester polyol have a number average molecular weight in the range of about 350 to 4,700, and more preferably about 400 to 3,000; and a hydroxy value in the range of about 70 to 400 mg KOH/g, and more preferably about 150 to 350 mg KOH/g. The half-esterification reaction of the polyester polyol can be carried out by a usual method, usually at a temperature between room temperature to about 80° C., using, if necessary, a basic catalyst such as a tertiary amine.

Examples of the polyhydric alcohols include ethylene glycol, butylene glycol, 1,6-hexanediol, trimethylolpropane, pentaerythritol, etc. Examples of polycarboxylic acids include adipic acid, sebacic acid, terephthalic acid, isophthalic acid, phthalic anhydride, hexahydrophthalic anhydride, trimellitic anhydride, etc. Examples of acid anhydride group-containing compounds include phthalic anhydride, hexahydrophthalic anhydride, succinic anhydride, trimellitic anhydride, etc.

It is preferable that the carboxy-containing, high-acid-value polyester have a number average molecular weight in the range of about 800 to 5,000, and more preferably about 900 to 4,000, and an acid value of about 50 to 300 mg KOH/g, and more preferably about 100 to 250 mg KOH/g.

Epoxy-Containing Acrylic Resin (B)

The epoxy-containing acrylic resin (B) functions as a crosslinking-curing agent for the carboxy-containing polymer (A) and carboxy-containing reaction product (C).

The epoxy-containing acrylic resin (B) may contain, in addition to an epoxy group, an alkoxysilyl group. When the acrylic resin (B) contains an alkoxysilyl group, the coating film formed from the coating composition containing the acrylic resin (B) has a higher crosslinking density, and is improved in scratch resistance and stain resistance.

The acrylic resin (B) can be synthesized by copolymerizing an epoxy-containing vinyl monomer with other vinyl monomers, or copolymerizing an epoxy-containing vinyl monomer, alkoxysilyl-containing vinyl monomer, and other vinyl monomers.

Examples of epoxy-containing vinyl monomers include glycidyl(meth)acrylate, allyl glycidyl ether, 3,4-epoxycyclohexylmethyl(meth)acrylate, etc.

Alkoxysilyl-containing vinyl monomers include, for example, vinyltrimethoxysilane, vinylmethyldimethoxysilane, vinyltriethoxysilane, vinylmethyldiethoxysilane, vinyltris(2-methoxyethoxy)silane, γ-(meth)acryloyloxypropyltrimethoxysilane, γ-(meth)acryloyloxypropylmethyldimethoxysilane, vinyltriacetoxysilane, β-(meth)acryloyloxyethyltrimethoxysilane, γ-(meth)acryloyloxypropyltriethoxysilane, γ-(meth)acryloyloxypropylmethyldiethoxysilane, etc. Of these, to obtain excellent low-temperature curability and storage stability, alkoxysilyl-containing vinyl monomers in which the alkoxysilyl groups are ethoxysilyl groups, such as vinyltriethoxysilane, vinylmethyldiethoxysilane, γ-(meth)acryloyloxypropyltriethoxysilane, γ-(meth) acryloyloxypropylmethyldiethoxysilane, etc.

Examples of other vinyl monomers are the same as those mentioned in the description of the polymer (A-1).

The copolymerization method mentioned in the description of the polymer (A-1) can be used for the copolymerization for producing the epoxy-containing acrylic resin (B).

To improve the compatibility of the epoxy-containing acrylic resin (B) with the carboxy-containing polymer (A) and reaction product (C), and to obtain a coating film with improved adhesion from the coating composition containing the acrylic resin (B), hydroxy groups can be introduced into the acrylic resin (B) to such an extent that the acrylic resin has a hydroxy value of about 150 mg KOH/g or less.

Hydroxy groups can be introduced by carrying out copolymerization using a hydroxy-containing vinyl monomer as a comonomer. Examples of hydroxy-containing vinyl monomers are the same as those mentioned in the description of the polymer (A-1).

When copolymerizing the epoxy-containing vinyl monomer with other vinyl monomers, from the viewpoint of the balance between the curing reactivity and storage stability of the resulting copolymer, the proportion of the epoxy-containing vinyl monomer is preferably about 5 to 80 mass %, and more preferably about 10 to 65 mass %. The proportion of other vinyl monomers is preferably about 20 to 95 mass %, and more preferably about 35 to 90 mass %.

For copolymerization of the epoxy-containing vinyl monomer, alkoxysilyl-containing vinyl monomer, and other monomers, it is usually preferable to use the monomers relative to the total amount of monomers used in the following proportions: the proportion of the epoxy-containing vinyl monomer is preferably about 5 to 60 mass %, and more preferably about 10 to 40 mass %, from the viewpoint of the balance between the curing reactivity and storage stability of the resulting copolymer; the proportion of the alkoxysilyl-containing vinyl monomer is preferably about 3 to 40 mass %, and more preferably about 5 to 30 mass %, to achieve excellent curing reactivity of the resulting copolymer and to obtain a coating film with excellent scratch resistance from the coating composition containing the resulting copolymer; and the proportion of the other vinyl monomers is preferably about 10 to 80 mass %, and more preferably about 20 to 50 mass %.

To achieve excellent compatibility of the acrylic resin (B) with the carboxy-containing polymer (A) and reaction product (C) and excellent curability of the resulting coating composition, and to obtain a coating film with excellent acid resistance, scratch resistance, etc., from the coating composition, the epoxy group content of the acrylic resin (B) is preferably about 0.5 to 5.5 mmol/g, and more preferably about 0.8 to 4.5 mmol/g.

When the acrylic resin (B) has an alkoxysilyl group or groups, the amount of alkoxysilyl groups is preferably about 0.05 to 2.5 mmol/g, and more preferably about 0.15 to 1.75 mmol/g, to achieve excellent storage stability of the coating composition and to obtain a coating film with excellent acid resistance, scratch resistance, etc., from the coating composition.

To achieve excellent compatibility of the acrylic resin (B) with the carboxy-containing polymer (A) and reaction product (C), and to obtain a coating film with excellent acid resistance, scratch resistance, etc., the acrylic resin (B) preferably has a number average molecular weight of about 1,000 to 10,000, and more preferably about 1,200 to 7,000.

Carboxy-Containing Reaction Product (C)

The carboxy-containing reaction product (C) is obtained by a half-esterification reaction of an acid anhydride with a polycarbonate polyol having three or more hydroxyl groups per molecule, and has an acid value of 50 to 200 mg KOH/g and a number average molecular weight of 600 to 5,000. The acid value of the carboxy-containing reaction product (C) is the half acid value.

A polycarbonate polyol having three or more hydroxyl groups per molecule, which is used for the synthesis of the reaction product (C), is a compound usually obtained by a polycondensation reaction of a known polyol with a carbonylating agent.

The polycarbonate polyol used for the synthesis of the reaction product (C) has an average of three or more hydroxyl groups per molecule.

To ultimately obtain a coating film with excellent acid resistance and scratch resistance from the coating composition, the polycarbonate polyol used for the synthesis of the reaction product (C) preferably has a number average molecular weight of about 300 to 2,000, more preferably about 500 to 1,800, and even more preferably about 700 to 1,500.

Additionally, the polycarbonate polyol used for the synthesis of the reaction product (C) preferably has a hydroxy value of 54 to 270 mg KOH/g. When the hydroxy value is less than the above range, the crosslinking density may be low, and this reduces the scratch resistance of the coating film. On the other hand, when the hydroxy value is greater than the above range, the crosslinking density may be too high, and reduces coating film properties.

Examples of polyol components used for the preparation of the polycarbonate polyol used for the synthesis of the reaction product (C) include trihydric or higher polyhydric alcohols and diols.

Examples of trihydric or higher polyhydric alcohols include glycerin, trimethylolethane, trimethylolpropane, trimethylolpropane dimer, pentaerythritol, etc.

Examples of diols include 1,3-propanediol, 1,4-butanediol, 1,5-pentanediol, 1,6-hexanediol, 1,7-heptanediol, 1,8-octanediol, 1,9-nonanediol, 1,10-decanediol, and like linear diols; 2-methyl-1,3-propanediol, 3-methyl-1,5-pentanediol, neopentyl glycol, 2-ethyl-1,6-hexanediol, 2,2-diethyl-1,3-propanediol, 2-butyl-2-ethyl-1,3-propanediol, 2-methyl-1,8-octanediol, 2,2,4-trimethyl-1,3-pentanediol, 2-ethyl-1,3-hexanediol, and like branched diols; 1,3-cyclohexanediol, 1,4-cyclohexanediol, 1,4-cyclohexanedimethanol, and like alicyclic diols; p-xylenediol, p-tetrachloroxylenediol, and like aromatic diols; diethylene glycol, dipropylene glycol, and like ether diols; etc. These diols can be used singly, or in a combination of two or more.

The proportion between trihydric or higher polyhydric alcohol and diol is preferably 0.75 or less, more preferably 0.5 or less in molar ratio of trihydric or higher polyhydric alcohol/diol.

Additionally, the proportion between trihydric or higher polyhydric alcohol and diol is preferably 0.1 or more, more preferably 0.2 or more in molar ratio of trihydric or higher polyhydric alcohol/diol.

Known carbonylating agents can be used. Specific examples include alkylene carbonate, dialkyl carbonate, diallyl carbonate, phosgene, etc. These carbonylating agents can be used singly, or in a combination of two or more. Of these, preferable examples include ethylene carbonate, propylene carbonate, dimethyl carbonate, diethyl carbonate, dibutyl carbonate, diphenyl carbonate, etc.

The polycarbonate polyol used for the synthesis of the reaction product (C) can also be synthesized by using a polycarbonate diol as a starting material, and adding a trihydric or higher polyhydric alcohol to the polycarbonate diol by an alcohol exchange reaction. The polycarbonate diol may be a commercial product. Specific examples include “T-5650J” (produced by Asahi Kasei Chemicals Corp.) “UM-CARB90 (1/1)” (produced by Ube Industries, Ltd.), etc. Examples of trihydric or higher polyhydric alcohols include glycerin, trimethylolethane, trimethylolpropane, trimethylolpropane dimer, pentaerythritol, etc.

The polycarbonate polyol used for the synthesis of the reaction product (C) preferably has a Brookfield viscosity of about 10,000 mPa·s or less at 50° C. When the Brookfield viscosity is more than 10,000 mPa·s at 50° C., it becomes difficult to handle the polycarbonate polyol, and the resulting coating film may have poor gloss or become cloudy because of poor compatibility of the reaction product (C) with the carboxy-containing polymer (A) and epoxy-containing acrylic resin (B).

The Brookfield viscosity at 50° C. of the polycarbonate polyol used for the synthesis of the reaction product (C) is more preferably about 10 to 10,000 mPa·s, still more preferably about 10 to 8,000 mPa·s, and even more preferably about 10 to 5,000 mPa·s.

As used herein, the Brookfield viscosity is measured using a Brookfield viscometer at 50° C. and 6 rpm.

Examples of acid anhydrides used for the synthesis of the reaction product (C) include anhydrides of polycarboxylic acids such as phthalic acid, tetrahydrophthalic acid, hexahydrophthalic acid, methylhexahydrophthalic acid, succinic acid, glutaric acid, pimelic acid, naphthalenedicarboxylic acid, 4,4-diphenyletherdicarboxylic acid, diphenylmethane-4,4′-dicarboxylic acid, HET acid, maleic acid, fumaric acid, itaconic acid, trimellitic acid, hexahydrotrimellitic acid, pyromellitic acid, etc. Such acid anhydrides can be used singly, or in a combination of two or more.

Of these, succinic anhydride, hexahydrophthalic anhydride, and trimellitic anhydride can be preferably used from the viewpoint of excellent acid resistance, scratch resistance, etc., of the coating film.

The reaction product (C) is usually synthesized under conditions that allow production of a compound having a structure in which terminal hydroxy groups of the polycarbonate polyol are converted to carboxy groups through half-esterification without polycondensation of the polycarbonate polyol with the acid anhydride. The reaction product (C) may contain an unreacted portion that is not half-esterified, as long as the reaction product (C) has an acid value and number average molecular weight within the specific ranges.

The optimum temperature for the half-esterification reaction varies depending mainly on the melting point and the like of the acid anhydride used. For example, when using hexahydrophthalic anhydride as the acid anhydride, the optimum temperature is about 120 to 180° C. Generally, a polycondensation reaction is likely to occur at temperatures of more than about 200° C.

The reaction product (C) can be synthesized by carrying out a half-esterification reaction of a polycarbonate polyol and an acid anhydride in such proportions that the equivalent ratio (acid anhydride groups in the acid anhydride/hydroxy groups in the polycarbonate polyol) is about 1.05 or less. To achieve excellent curability of the coating composition and excellent water resistance and other properties of the coating film, the equivalent ratio is preferably about 0.25 to 1.05, more preferably about 0.5 to 1.0, and even more preferably about 0.75 to 1.0.

In the reaction product (C), generally, the lower the equivalent ratio, the greater the proportion of a compound having a structure in which a hydroxy group or groups in the polycarbonate polyol remain; and the higher the equivalent ratio, the greater the proportion of a compound having a structure in which all of the hydroxy groups in the polycarbonate polyol have been converted to carboxy groups.

Further, the lower the equivalent ratio, the greater the amount of unreacted polycarbonate polyol remaining in the reaction product (C). In the present invention, hydroxy groups in the polycarbonate polyol can also be reacted with epoxy groups or alkoxysilyl groups. Therefore, the reaction product (C) containing remaining polycarbonate polyol can usually be used as is, without isolating unreacted polycarbonate polyol.

The reaction product (C) must have an acid value of about 50 to 200 mg KOH/g in order to achieve the following: excellent compatibility of the reaction product (C) with the carboxy-containing polymer (A) and epoxy-containing acrylic resin (B); excellent curability of the coating composition obtained using the reaction product (C); and excellent coating film performance in terms of scratch resistance, water resistance, etc., of the coating film formed from the coating composition. For the same viewpoint, the reaction product (C) preferably has an acid value of about 50 to 150 mg KOH/g, and more preferably about 60 to 130 mg KOH/g.

To achieve excellent compatibility of the reaction product (C) with the carboxy-containing polymer (A) and epoxy-containing acrylic resin (B), and to obtain a coating film with excellent coating film performance in terms of scratch resistance, hardness, weather resistance, etc., the reaction product (C) must have a number average molecular weight of about 600 to 5,000. For the same viewpoint, the reaction product (C) preferably has a number average molecular weight of about 700 to 3,000, and more preferably about 800 to 2,000.

From the viewpoint of excellent curability and other properties of the resulting coating composition, the reaction product (C) preferably has a hydroxy value of about 0 to 150 mg K OH/g, and more preferably about 0 to 130 mg KOH/g.

In the present invention, the acid value, number average molecular weight, and hydroxy value of the reaction product (C) mean those of the reaction product as a whole including polycarbonate polyol that remains unreacted.

In the coating composition of the present invention, to achieve excellent curing reactivity of the coating composition, the proportions of the carboxy-containing polymer (A), epoxy-containing acrylic resin (B), and carboxy-containing reaction product (C) are preferably such that the equivalent ratio of carboxy groups in the components (A) and (C) relative to epoxy groups in the component (B) is about 1:0.5 to 0.5:1, and more preferably about 1:0.6 to 0.6:1.

Further, to achieve excellent coating film performance in terms of scratch resistance, hardness, stain resistance, etc., the proportions of the carboxy-containing polymer (A) and carboxy-containing reaction product (C) are such that, on a solids basis, the component (A) is preferably about 20 to 90 mass %, more preferably about 25 to 90 mass %, even more preferably about 30 to 90 mass %; and the component (C) is about 10 to 80 mass %, more preferably about 10 to 75 mass %, and even more preferably about 10 to 70 mass %, relative to the total amount of the components (A) and (C).

Further, to obtain a coating film with excellent scratch resistance, hardness, stain resistance, etc., the proportions of the carboxy-containing polymer (A), acrylic resin (B), and carboxy-containing reaction product (C) are such that, on a solids basis, the total amount of the components (A) and (C) is preferably about 20 to 80 mass %, more preferably about 35 to 65 mass %; and the component (B) is preferably about 80 to 20 mass %, more preferably about 65 to 35 mass %, relative to the total amount of the components (A), (B), and (C).

Further, to obtain a coating film with excellent acid resistance, scratch resistance, hardness, stain resistance, etc., the proportion of the carboxy-containing reaction product (C) is, on a solids basis, preferably about 3 to 40 mass %, particularly about 5 to 35 mass %, relative to the total amount of the carboxy-containing polymer (A), epoxy-containing acrylic resin (B), and reaction product (C).

### Other Components

The coating composition of the present invention may contain a curing catalyst, if necessary. Usable curing catalysts include those that are effective for the crosslinking reaction of carboxy groups and epoxy groups, such as tetraethylammonium bromide, tetrabutylammonium bromide, tetraethylammonium chloride, tetrabuthylphosphonium bromide, triphenylbenzyl sulfonium chloride and like quaternary salt catalysts; triethylamine, tributylamine and like amine-based catalysts; etc. Among these, quaternary salt catalysts are preferable. A mixture of substantially equivalent amounts of a quaternary salt and a phosphoric acid compound such as monobutyl phosphate, dibutyl phosphate, or the like, is particularly preferable, because such a mixture improves the storage stability of the coating composition and prevents the decrease of spray coating suitability caused by the reduction of the electric resistance of the coating composition, while retaining the catalytic action.

The coating composition of the present invention may contain a dehydrating agent, such as trimethyl orthoacetate, in order to suppress the deterioration of the coating composition caused by moisture that is present in the coating composition and in the air.

The coating composition of the present invention may contain known pigments, such as coloring pigments, extender pigments, luster pigments, rust preventive pigments, etc., if necessary.

Examples of coloring pigments include titanium oxide, zinc white, carbon black, cadmium red, molybdenum red, chrome yellow, chromium oxide, Prussian blue, cobalt blue, azo pigments, phthalocyanine pigments, quinacridone pigments, isoindoline pigments, threne pigments, perylene pigments, etc. Examples of extender pigments include talc, clay, kaolin, baryta, barium sulfate, barium carbonate, calcium carbonate, silica, alumina white, etc. Examples of luster pigments includes aluminum powder, mica powder, titanium oxide-coated mica powder, etc.

The coating composition of the present invention may also contain, if necessary, various resins such as acrylic resins, polyester resins, alkyd resins, silicon resins, fluororesins, etc. The composition may further contain a small amount of crosslinking agent, such as a melamine resin, blocked polyisocyanate compound, etc. Further, it is also possible to add conventional additives for coating compositions, such as UV absorbers, light stabilizers, anti-oxidants, surface adjusting agents, anti-foaming agents, etc., as required.

Known UV absorbers can be used, including, for example, benzotriazol UV absorbers, triazine UV absorbers, salicylic acid derivative UV absorbers, benzophenone UV absorbers, etc. The use of a UV absorber improves the weather resistance, yellowing resistance, etc., of the coating film.

The proportion of UV absorber in the coating composition is usually about 0 to 10 parts by mass, preferably about 0.2 to 5 parts by mass, and more preferably about 0.3 to 2 parts by mass, per 100 parts by mass of the total resin solids in the composition.

Known light stabilizers are usable, including, for example, hindered amine light stabilizers and the like. The use of a light stabilizer improves the weather resistance, yellowing resistance, etc., of the coating film.

The proportion of light stabilizer in the coating composition is usually about 0 to 10 parts by mass, preferably about 0.2 to 5 parts by mass, and more preferably about 0.3 to 2 parts by mass, per 100 parts by mass of the total resin solids in the composition.

The form of the coating composition of the present invention is not limited; however, the composition is usually used as an organic solvent-based coating composition. In that case, usable organic solvents include various organic solvents for coating compositions, such as aromatic or aliphatic hydrocarbon solvents; alcohol solvents; ester solvents; ketone solvents; ether solvents; etc. To prepare the organic solvent-based coating composition, the organic solvent used for preparing the components (A), (B), (C), or the like, may be used as such; or an organic solvent may be further added.

### Method for Preparing Coating Composition

The coating composition of the present invention can be prepared by mixing, by a known method, carboxy-containing polymer (A), epoxy-containing acrylic resin (B), carboxy-containing reaction product (C) and optional components such as polycarbonate polyol, curing catalysts, pigments, resins, UV absorbers, light stabilizers, organic solvents, etc. The solids content of the coating composition of the present invention is preferably about 30 to 70 mass %, and more preferably about 40 to 60 mass %.

### Application Method

The coating composition of the invention can be advantageously used in various application methods, as described below.

### Substrates to be Coated

Examples of substrates to be coated include bodies of automobiles, motorcycles, and like vehicles; parts thereof; etc. Examples of substrates also include those that constitute such vehicle bodies and the like, such as cold rolled steel sheets and plates, galvanized steel sheets and plates, zinc alloy-plated steel sheets and plates, stainless steel sheets and plates, tinned steel sheets and plates, and like steel sheets and plates, aluminum sheets and plates, aluminum alloy sheets and plates, and like metal substrates; plastic substrates; and the like.

Usable substrates also include such vehicle bodies, parts, and metal substrates whose metal surface has been subjected to a chemical conversion treatment such as phosphate treatment, chromate treatment, composite oxide treatment, or the like. Usable substrates further include such vehicle bodies, metal substrates, and the like, onto which an undercoat, such as an electrodeposition undercoat, and/or an intermediate coat, has been formed.

### Application and Curing Method

The method of applying the coating composition of the invention is not limited. For example, air spray coating, airless spray coating, rotary atomization coating, curtain coating, and like application methods can be used to form a wet coat. In air spray coating, airless spray coating, and rotary atomization coating, an electrostatic charge may be applied, if necessary. Among these, air spray coating and rotary atomization coating are particularly preferable. It is usually preferable to apply the coating composition to a film thickness of about 10 to 50 μm (when cured).

The wet coat is cured by heating. Heating can be performed by known heating means. For example, drying furnaces, such as hot air furnaces, electric furnaces, infrared induction heating furnaces, etc., can be used.

The heating temperature is usually about 100 to 180° C., and preferably about 120 to 160° C. The heating time is usually about 10 to 40 minutes.

### Method of Forming Multilayer Coating Film

The coating composition of the present invention is capable of forming a coating film with excellent performance in terms of scratch resistance, acid resistance, stain resistance, gloss, etc. It is therefore preferable to use the coating composition as a clear coating composition for forming a top clear coat, in a method for forming a multilayer topcoat film on a substrate.

The multilayer coating film forming method of the invention is therefore a method for forming on a substrate one or two colored base coating layers and one or two clear coating layers, the uppermost clear coating layer being formed by using the coating composition of the invention.

In particular, preferable substrates to which the multilayer coating film forming method of the invention can be applied are automobile bodies and parts thereof.

Specific examples of the multilayer coating film forming method of the invention include the following methods a to c, wherein the coating composition of the invention is used to form the top clear coating layer.

Method a: a two-coat method for forming a multilayer topcoat film, wherein a colored base coating layer and a top clear coating layer are formed in that order on a substrate.

Method b: a three-coat method for forming a multilayer coating film, wherein a colored base coating layer, a clear coating layer and a top clear coating layer are formed in that order on a substrate.

Method c: a three-coat method for forming a multilayer coating film, wherein a first colored base coating layer, a second colored base coating layer, and a top clear coating layer are formed in that order on a substrate.

The steps for forming a topcoat film in methods a, b, and c are described below in detail.

In the above methods, the colored base coating composition and the clear coating composition can be applied by application methods such as airless spray coating, air spray coating, rotary atomization coating, etc. In such application methods, an electrostatic charge may be applied, if necessary.

In method a, a known colored coating composition can be used for forming the colored base coating layer.

A coating composition for automobile bodies or the like is preferably used as the colored base coating composition.

The colored base coating composition is an organic solvent-based or aqueous coating composition comprising a base resin, a crosslinking agent, a coloring pigment, a metallic pigment, a light interference pigment, an extender pigment, etc.

As the base resin, at least one member selected from the group consisting of acrylic resins, vinyl resins, polyester resins, alkyd resins, urethane resins, and the like can be used. Such base resins have crosslinkable functional groups such as hydroxy, epoxy, carboxy, alkoxysilyl, oxazolinyl, carbodiimide, and the like. As the crosslinking agent, at least one member selected from the group consisting of alkyl-etherified melamine resins, urea resins, guanamine resins, polyisocyanate compounds, blocked polyisocyanate compounds, epoxy compounds, carboxy-containing compounds, oxazolinyl-containing compounds, carbodiimide-containing compounds, and the like, can be used. The proportions of base resin and crosslinking agent are preferably about 50 to 90 wt % of base resin, and about 50 to 10 wt % of crosslinking agent, relative to the total amount of these components.

In method a, the colored base coating composition is applied to a substrate to a film thickness of about 10 to 50 μm (when cured). The applied base coating composition is either cured by heating at about 100 to 180° C., preferably at about 120 to 160° C., for about 10 to 40 minutes; or is not cured, with the coated substrate being left to stand at room temperature for several minutes, or being preheated at about 40 to 100° C. for about 1 to 20 minutes.

Subsequently, the coating composition of the invention is applied to a film thickness of about 10 to 70 μm (when cured) to form a top clear coating layer, and then heated to form a cured multilayer coating film. The heating is performed at about 100 to 180° C., preferably at about 120 to 160° C., for about 10 to 40 minutes.

Of the above two-coat methods, the method comprising applying a base coating composition, applying a clear coating composition without heat-curing the base coating layer, and then curing the resulting two coating layers simultaneously is referred to as a two-coat one-bake method. The method comprising applying and heat-curing a base coating composition, and then applying and curing a clear coating composition is referred to as a two-coat two-bake method.

In method b, examples of usable colored base coating compositions are the same as those described in method a. The first clear coating composition for forming a clear coating layer may be any composition for forming clear coating films. Examples of usable clear coating compositions include those that have formulations similar to the above-mentioned known colored base coating compositions, but contain no or substantially no pigment. The coating composition of the invention is used as the second clear coating composition for forming the top clear coating layer. Alternatively, the clear coating composition of the invention may also be used as the first clear coating composition, so that both the clear coating layer and the top clear coating layer are formed from the clear coating composition of the invention.

In method b, similar to method a, a colored base coating composition is applied to the substrate, and is either cured by heating; or not cured, with the coated substrate being left to stand at room temperature for several minutes or being preheated. Thereafter, a first clear coating composition is applied to the surface of the colored base coating layer to a film thickness of about 10 to 50 μm (when cured), and is either cured by heating at about 100 to 180° C., preferably at about 120 to 160° C., for about 10 to 40 minutes; or is not cured, with the coated substrate being left to stand at room temperature for several minutes, or being preheated.

Subsequently, the coating composition of the invention is applied as a second clear coating composition to a film thickness of about 10 to 50 μm (when cured) and then heated to form a cured multilayer coating film. The heating conditions are as in method a.

The method comprising applying a base coating composition, applying a first clear coating composition without heat-curing the base coating layer, applying a second clear coating composition without curing the first clear coating layer, and then curing the resulting three coating layers simultaneously is referred to as a three-coat one-bake method. The method comprising applying a base coating composition, applying a first clear coating composition without heat-curing the base coating layer, curing the resulting two coating layers simultaneously, and then applying and curing a second clear coating composition is referred to as a three-coat two-bake method. The method comprising applying and heat-curing a base coating composition, applying and curing a first clear coating composition, and applying and curing a second clear coating composition is referred to as a three-coat three-bake method.

Examples of colored base coating compositions usable as the first colored base coating composition in method c are the same as described in method a.

In method c, similar to method a, a first colored base coating composition is applied to the substrate, and is either cured by heating; or not cured, with the coated substrate being left to stand at room temperature for several minutes, or being preheated. The second colored base coating composition is then applied to the surface of the first colored base coating layer to a film thickness of about 10 to 50 μm (when cured), and is either cured by heating at about 100 to 180° C., preferably at about 120 to 160° C., for about 10 to 40 minutes; or not cured, with the coated substrate being left to stand at room temperature for several minutes, or being preheated.

Subsequently, the coating composition of the invention is applied as a composition for forming a top clear coating layer, to a film thickness of about 10 to 50 μm (when cured) and heated to form a cured multilayer coating film. The heating conditions are as in method a.

The method comprising applying a first base coating composition, applying a second base coating composition without heat-curing the first base coating layer, applying a clear coating composition without curing the second base coating layer, and then curing the resulting three coating layers simultaneously is referred to as a three-coat one-bake method. The method comprising applying and heat-curing a first base coating composition, applying a second base coating composition, applying a clear coating composition without curing the second base coating layer, and then curing the resulting two coating layers simultaneously is referred to as a three-coat two-bake method. The method comprising applying and heat-curing a first base coating composition, applying and curing a second base coating composition, and applying and curing a clear coating composition is referred to as a three-coat three-bake method.

### EXAMPLES

The following Production Examples, Examples, and Comparative Examples are provided to illustrate the present invention in further detail, and are not intended to limit the scope of the invention. In the following examples, parts and percentages are by mass unless otherwise stated, and the film thickness is the thickness of a cured coating film.

### Production of Carboxy-Containing Polymer (A)

### Production Example 1

A 680-part quantity of “Swasol 1000” (tradename of Cosmo Oil Co., Ltd., hydrocarbon organic solvent) was added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and the following monomer mixture I consisting of monomers, solvent, and polymerization initiator (p-tert-butyl peroxy-2-ethylhexanoate), was added dropwise over a period of 4 hours.

Monomer Mixture I

| | | |
|---|---|---|
| Styrene | 500 | parts |
| Cyclohexyl methacrylate | 400 | parts |
| Isobutyl methacrylate | 500 | parts |
| Maleic anhydride | 600 | parts |
| 2-Ethoxyethyl propionate | 1,000 | parts |
| p-Tert-butylperoxy-2-ethylhexanoate | 100 | parts |

Aging was carried out at 125° C. for 30 minutes under aeration with nitrogen gas, and then a mixture of 10 parts of p-tert-butylperoxy-2-ethylhexanoate and 80 parts of “Swasol 1000” was added dropwise over a period of 1 hour. After cooling to 60° C., 490 parts of methanol and 4 parts of triethylamine were added, and a half-esterification reaction was carried out under reflux for 4 hours.

Remaining methanol was then removed under reduced pressure to thereby obtain a solution of carboxy-containing polymer (A-1).

The obtained polymer solution had a solids content of 55 mass %, and a number average molecular weight of about 3,500. The polymer had a half-acid value of 160 mg KOH/g.

### Production Example 2

A 680-part quantity of “Swasol 1000” was added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and the following monomer mixture II consisting of monomers, solvent, and polymerization initiator (p-tert-butyl peroxy-2-ethylhexanoate), was added dropwise over a period of 4 hours.

Monomer Mixture II

| | | |
|---|---|---|
| Styrene | 500 | parts |
| Cyclohexyl methacrylate | 400 | parts |
| Isobutyl methacrylate | 880 | parts |
| Maleic anhydride | 220 | parts |
| 2-Ethoxyethyl propionate | 1,000 | parts |
| p-Tert-butylperoxy-2-ethylhexanoate | 100 | parts |

Aging was carried out at 125° C. for 30 minutes under aeration with nitrogen gas, and then a mixture of 10 parts of p-tert-butylperoxy-2-ethylhexanoate and 80 parts of “Swasol 1000” was added dropwise over a period of 1 hour. After cooling to 60° C., 183 parts of methanol and 4 parts of triethylamine were added, and a half-esterification reaction was carried out under reflux for 4 hours. Remaining methanol was then removed under reduced pressure to thereby obtain a solution of carboxy-containing polymer (A-2).

The obtained polymer solution had a solids content of 55 mass %, and a number average molecular weight of about 3,500. The polymer had a half-acid value of 60 mg KOH/g.

### Production Example 3

A 680-part quantity of “Swasol 1000” was added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and the following monomer mixture II consisting of monomers, solvent, and polymerization initiator (p-tert-butyl peroxy-2-ethylhexanoate), was added dropwise over a period of 4 hours.

Monomer Mixture II

| | | |
|---|---|---|
| Styrene | 500 | parts |
| Cyclohexyl methacrylate | 400 | parts |
| Isobutyl methacrylate | 200 | parts |
| Maleic anhydride | 900 | parts |
| 2-Ethoxyethyl propionate | 1,000 | parts |
| p-Tert-butylperoxy-2-ethylhexanoate | 100 | parts |

Aging was carried out at 125° C. for 30 minutes under aeration with nitrogen gas, and then a mixture of 10 parts of p-tert-butylperoxy-2-ethylhexanoate and 80 parts of “Swasol 1000” was added dropwise over a period of 1 hour. After cooling to 60° C., 735 parts of methanol and 4 parts of triethylamine were added, and a half-esterification reaction was carried out under reflux for 4 hours. Remaining methanol was then removed under reduced pressure to thereby obtain a solution of carboxy-containing polymer (A-3).

The obtained polymer solution had a solids content of 55 mass %, and a number average molecular weight of about 3,500. The polymer had a half-acid value of 240 mg KOH/g.

### Production Example 4

A 566-part quantity of 1,6-hexanediol, 437 parts of trimethylolpropane, 467 parts of adipic acid, and 308 parts of hexahydrophthalic anhydride were added to a four-necked flask equipped with a stirrer, a thermometer, a condenser tube, and a nitrogen gas inlet; heated to 180° C. under a nitrogen atmosphere; and then heated to 230° C. over a period of 3 hours. After carrying out a reaction at 230° C. for 1 hour, xylene was added, and the resulting mixture was reacted under reflux. After confirming that the resin acid value had become 3 mg KOH/g or less, the reaction mixture was cooled to 100° C., and 1,294 parts of hexahydrophthalic anhydride was added. The reaction mixture was then heated to 140° C., and a reaction was carried out for 2 hours. After cooling, the reaction mixture was diluted with xylene to thereby obtain a solution of carboxy-containing, high-acid value polyester (A-4). The obtained polymer solution had a solids content of 65 mass %. The polyester had a number average molecular weight of 1,040, and a resin acid value of 160 mg KOH/g.

### Production Example of Epoxy-Containing Acrylic Resin (B)

### Production Examples 5-9

A 410-part quantity of xylene and 77 parts of n-butanol were added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and a monomer mixture consisting of the monomers and polymerization initiator shown in Table 1 was uniformly added dropwise over a period of 4 hours. Note that 2,2′-azobisisobutyronitrile is a polymerization initiator.

Aging was carried out at 125° C. for 30 minutes under aeration with nitrogen gas; and then a mixture of 90 parts of xylene, 40 parts of n-butanol, and 14.4 parts of 2,2′-azobisisobutyronitrile was further added dropwise over a period of 2 hours, followed by aging for 2 hours. Solutions of epoxy-containing acrylic resins (B-1) to (B-5) were thereby obtained. Table 1 shows the amounts (parts) of monomers, mass solids concentration (%) of the obtained acrylic resin solutions, and properties of the acrylic resins.

TABLE 1

| | | Production Example No. | | | | |
|---|---|---|---|---|---|---|
| | | 5 | 6 | 7 | 8 | 9 |
| Epoxy-Containing Acrylic Resin (B) No. | | B-1 | B-2 | B-3 | B-4 | B-5 |
| Monomer | Glycidyl Methacrylate | 432 | 202 | 821 | 432 | 432 |
| | n-Butyl Acrylate | 720 | 950 | 331 | 576 | |
| | Styrene | 288 | 288 | 288 | 288 | 288 |
| | γ-Methacryloyloxypropyl Triethoxysilane | | | | 144 | 720 |
| Initiator | 2,2′-Azobisisobutylonitrile | 72.0 | 72.0 | 72.0 | 72.0 | 72.0 |
| Properties | Mass Solids Concentration (%) | 70 | 70 | 70 | 70 | 70 |
| | Number Average Molecular Weight | 2000 | 2000 | 2000 | 2000 | 200 |
| | Epoxy Content (mmol/g) | 2.12 | 0.99 | 4.03 | 2.12 | 2.12 |
| | Alkoxysilyl Content (mmol/g) | | | | 0.34 | 1.72 |

### Production of Carboxy-Containing Reaction Product (C)

### Production Examples 10-21

Monomers in the amounts as shown in Table 2, and 40 mg of tetra-n-butoxytitanium were added to a four-necked flask equipped with a stirrer, a thermometer, a condenser tube, and a nitrogen gas inlet. The mixture was allowed to react under aeration with nitrogen gas while distilling off methanol, at a temperature of 95 to 160° C., that was produced as a byproduct. After the distillation of methanol became almost unobservable, the pressure was reduced to 10 mmHg or less, followed by further reaction for 4 hours. Thereafter, trimethylolpropane, which is an added monomer, was placed in the flask in an amount shown in Table 2, and the pressure in the flask was reduced to 10 mmHg or less, followed by stirring and heating. The reaction temperature was gradually increased to 200° C., and the mixture was allowed to react while distilling off the by-produced diol monomer. The reaction was continued until the distillate was no longer generated, obtaining diol monomer.

Subsequently, “Swasol 1000” (tradename, product of Cosmo Oil Co., Ltd., hydrocarbon organic solvent) was added to the mixture in an amount shown in Table 2, and the temperature was increased to 130° C. under a nitrogen atmosphere. After the temperature reached 130° C., an acid anhydride was further added thereto in each of the amounts shown in Table 2. The resulting mixtures were allowed to react for 2 hours, obtaining solutions of carboxy-containing reaction products (C-1) to (C-12).

Table 2 shows the amounts (parts) of monomers and hydrocarbon-based organic solvents, and the mass solids concentration (%) and properties of the resulting carboxy-containing reaction products.

### Production Example 22

By subjecting T-5650J (tradename of Asahi Kasei Chemicals Corp.; polycarbonate diol comprising 1,6-hexanediol and 1,5-pentanediol as diol components; number average molecular weight: 800; viscosity: 860 mPa·s; hydroxy value: 140 mg KOH/g; solids content: 100%) and hexahydrophthalic anhydride, which is an acid anhydride, to an addition reaction in the proportions shown in Table 2 in “Swasol 1000” solvent, obtaining carboxy-containing reaction product (C-13).

Table 2 shows the amounts (parts) of monomers and hydrocarbon-based organic solvents, and the mass solids concentration (%) and properties of the resulting carboxy-containing reaction products.

TABLE 2

| | | Production Example No. | | | | | | | | | | | | |
|---|---|---|---|---|---|---|---|---|---|---|---|---|---|---|
| | | 10 | 11 | 12 | 13 | 14 | 15 | 16 | 17 | 18 | 19 | 20 | 21 | 22 |
| Carboxy-Containing Reaction Product No. | | C-1 | C-2 | C-3 | C-4 | C-5 | C-6 | C-7 | C-8 | C-9 | C-10 | C-11 | C-12 | C-13 |
| Monomer | 1,6-Hexanediol | 236 | 354 | 118 | 236 | 236 | 354 | 236 | 236 | 236 | 236 | 236 | 236 | |
| | 1,4-Cyclohexane | 288 | | 432 | 288 | 288 | 144 | | 288 | 288 | 288 | 288 | 288 | |
| | dimethanol | | | | | | | | | | | | | |
| | 1,4-Cyclohexanediol | | 116 | | | | | 232 | | | | | | |
| | Trimethylolpropane | | | | | | 67 | | | | | | | |
| | Dimethyl Carbonate | 450 | 450 | 270 | 450 | 450 | 450 | 720 | 270 | 765 | 450 | 450 | 180 | |
| Added Monomer | Trimethylolpropane | 134 | 134 | 134 | 134 | 134 | | 134 | 134 | 134 | 134 | 134 | 134 | |
| Polycarbonate Diol | T5650J | | | | | | | | | | | | | 500 |
| Solvent | Swasol 1000 | 640 | 557 | 385 | 557 | 557 | 814 | 788 | 385 | 808 | 428 | 471 | 214 | 300 |
| Acid Anhydride | Hexahydro phthalic anhydride | 462 | 308 | 308 | | | 462 | 462 | 462 | 462 | | 77 | 231 | 201.5 |
| | Succinic Anhydride | | | | 300 | | | | | | | | | |
| | Trimellitic Anhydride | | | | | 288 | | | | | | | | |
| Properties | Polycarbonate Polyol Hydroxy | 168 | 168 | 267 | 168 | 168 | 112 | 53 | 267 | 37 | 168 | 168 | 561 | |
| | Value (mg KOH/g) | | | | | | | | | | | | | |
| | Polycarbonate Polyol | 1/1 | 1/0.67 | 1/0.67 | 1/1 | 1/0.5 | 1/1 | 1/1 | 1/1 | 1/1 | 1/0 | 1/0.67 | 1/0.5 | |
| | Hydroxy/Acid anhydrous | | | | | | | | | | | | | |
| | group molar ratio | | | | | | | | | | | | | |
| | Polycarbonate Diol Hydroxy | | | | | | | | | | | | | 140 |
| | Value (mg KOH/g) | | | | | | | | | | | | | |
| | Polycarbonate Diol | | | | | | | | | | | | | 1/1 |
| | Hydroxy/Acid anhydrous | | | | | | | | | | | | | |
| | group molar ratio | | | | | | | | | | | | | |
| | Mass Solids Concentration (%) | 70 | 70 | 70 | 70 | 70 | 70 | 70 | 70 | 70 | 70 | 70 | 70 | 70 |
| | Number Average Molecular | 1500 | 1300 | 630 | 1300 | 1300 | 1900 | 4800 | 800 | 5100 | 1000 | 1100 | 500 | 1000 |
| | Weight | | | | | | | | | | | | | |
| | Acid Value (mg KOH/g) | 112 | 68 | 198 | 129 | 129 | 89 | 51 | 210 | 33 | 0 | 26 | 168 | 110 |
| | Hydroxy Value | 0 | 43 | 89 | 0 | 129 | 0 | 0 | 0 | 0 | 168 | 127 | 168 | 0 |

### Production of Coating Composition

### Examples 1-18 and Comparative Examples 1-7

The carboxy-containing polymer (A), epoxy-containing acrylic resin (B) and carboxy-containing reaction product (C), all obtained in the Production Examples; and other components, such as a curing catalyst, and the like, were mixed by stirring using a rotor blade stirrer. Coating compositions No. 1 to 25 were thus obtained.

Table 3 shows the components, equivalent ratio of carboxy groups/epoxy groups, and mass solids concentration (%), of the coating compositions.

In Table 3, the amounts of the components are parts on a solids basis; and (*1) to (*4) indicate the following:

(*1) Catalyst: a mixture of equivalent amounts of tetrabutylammonium bromide and monobutyl phosphate

(*2) “UV1164”: tradename of Ciba-Geigy; UV absorber; 2,4-bis(2,4-dimethylphenyl)-6-(2-hydroxy-4-isooctyloxyphenyl)-1,3,5-triazine

(*3) “HALS292”: tradename of Ciba-Geigy; light stabilizer; mixture of bis(1,2,2,6,6-pentamethyl-4-piperidyl)sebacate, and methyl(1,2,2,6,6-pentamethyl-4-piperidyl)sebacate

(*4) “BYK-300”: tradename of BYK-Chemie; surface adjusting agent; polyether-modified polydimethylsiloxane

### Performance Test of the Coating Compositions

### Preparation of Coated Test Plates

(1) “Swasol 1000” was added to coating compositions No. 1 to No. 25 obtained in the Examples and Comparative Examples, to adjust the viscosity to 25 sec (Ford cup #4 at 20° C.)

(2) A thermosetting epoxy resin cationic electrodeposition coating composition (tradename “Elecron GT-10”, product of Kansai Paint Co., Ltd.) was applied by electrodeposition to a 0.8 mm-thick, zinc phosphate-treated dull steel plate to a film thickness of 20 μm, and cured by heating at 170° C. for 30 minutes. Subsequently, a polyester resin/melamine resin intermediate coating composition for automobiles (tradename “Amilac TP-65-2”; coating color: black; product of Kansai Paint Co., Ltd.) was applied to the electrodeposition coat by air spraying to a film thickness of 35 μm, and cured by heating at 140° C. for 30 minutes. The steel plate having the electrodeposition coat and intermediate coat was used as a substrate.

(3) An acrylic resin/melamine resin base coating composition for automobile topcoats (tradename “Aqueous Metallic Base coating WBC 713T#202”; product of Kansai Paint Co., Ltd.; coating color: black) was applied to the substrate obtained in (2) by air spraying to a film thickness of about 15 μm, allowed to stand at room temperature for 5 minutes, and preheated at 80° C. for 10 minutes. Each of the above coating compositions No. 1 to No. 25 with a viscosity as adjusted in (1) was applied on the above-obtained uncured coating layer by rotary atomization to a film thickness of about 35 μm. The coated substrate was allowed to stand at room temperature for 10 minutes, and then heated at 140° C. for 20 minutes to cure the resulting two coating layers simultaneously. Thus, coated test plates were obtained in which a multilayer topcoat film consisting of a base coating layer and a clear coating layer was formed on a substrate by a two-coat one-bake method.

(4) Coated test plates for the stain resistance test were prepared as follows: the procedure described in (2) above was followed, except that a polyester resin/melamine resin intermediate coating composition for automobiles (tradename “Amilac TP-65-2”; coating color: white; product of Kansai Paint Co., Ltd.) was used in place of the polyester resin/melamine resin intermediate coating composition for automobiles (tradename “Amilac TP-65-2”; coating color: black; product of Kansai Paint Co., Ltd.), to obtain a white-color substrate; and the procedure described in (3) above was followed, except that each of the coating compositions No. 1 to No. 25 was applied to the substrate, without applying the base coating composition for topcoats.

### Film Performance Test

The obtained coated test plates were allowed to stand at room temperature for 7 days, and then tested for film performance in terms of scratch resistance, acid resistance, gloss, and stain resistance. Table 3 shows the results. The test methods are as follows.

### Test Methods

(i) Scratch resistance: the coated test plate was attached to the roof of an automobile body using water-resistant adhesive double-coated tape (product of Nichiban Co., Ltd.), and the automobile body with the coated test plate was washed 15 times in a car wash at 20° C. Thereafter, the 20° specular reflection (20° gloss) of the coated test plate was measured, and the gloss retention (%) relative to the 20° gloss before washing was calculated to evaluate the scratch resistance. The higher the gloss retention, the better the scratch resistance. The car wash used was “PO20 FWRC” (tradename of Yasui Sangyo K.K.).

(ii) Acid resistance: 0.4 cc of 40% aqueous sulfuric acid solution was dropped onto the coating film of the coated test plate. The coated test plate was then heated for 15 minutes on a hot plate heated to 60° C., and washed with water. The etching depth (μm) of the portion at which the sulfuric acid solution had been dropped was measured using a surface roughness tester (tradename “Surfcom 570A”, product of Tokyo Seimitsu Co., Ltd.), with a cutoff of 0.8 mm (scanning rate of 0.3 mm/sec, magnification of 5,000 times), to evaluate the acid resistance. The smaller the etching depth, the better the acid resistance.

(iii) Gloss: The 20° specular reflection (20° gloss) of the coated test plate was measured using a Handy Glossmeter (tradename “HG-268”, product of Suga Test Instruments Co., Ltd.).

(iv) Stain resistance: The coated test plate was subjected to accelerated weathering in an accelerated weathering tester (tradename “Sunshine Weather-O-Meter”, product of Suga Test Instruments Co., Ltd.) for 600 hours under the conditions according to JIS K5400. Thereafter, a staining material made of a mixture of mud, carbon black, mineral oil, and clay was applied to a piece of flannel and lightly rubbed onto the coating surface of the coated test plate. The coated test plate was then allowed to stand in a constant temperature, constant humidity room at 20° C. with a relative humidity of 75% for 24 hours, and then the coating surface was washed with running water. The degree of staining of the coating film was evaluated according to the difference in lightness (ΔL) on the coated plate. ΔL was calculated according to the following formula.

ΔL=(L value before the stain resistance test)−(L value after the stain resistance test)

The L value was measured using a tristimulus value-direct reading colorimeter (tradename “CR400”; product of Konica Minolta Co., Ltd.) using a D65 light source, with a visual field of 2 degrees, and with diffused lighting vertical reception (d/0). The L value is based on the CIE 1976 L*a*b* color system.

The degree of staining of the coating film was evaluated according to the following criteria. The smaller the ΔL value, the better the stain resistance.

a: ΔL<0.2

b: 0.2≦ΔL<0.5

c: 0.5≦ΔL<1

d: 1≦ΔL<2

e: 2≦ΔL

(v) NSR (Non-Sand Recoat Adhesion);

Test plates were prepared in the same manner as (1) to (3) in the above-described “Preparation of Coated Test Plates”, except that the conditions for curing the coating films after applying Coating Compositions No. 1 to 25 were changed to at 160° C. for 20 minutes. Water-based metallic basecoat WBC713T#202 was re-applied to each of the above-obtained test plates in such a manner that the film thickness became 15 μm. The test plates were allowed to stand at room temperature for 5 minutes, and then preheated at 80° C. for 10 minutes. After the conduction of preheating, the same coating composition as that previously applied was re-applied on the uncured coating film of each test plate in such a manner that the film thickness became 35 μm. After allowing the test plates to stand at room temperature for 10 minutes, the test plates were heated at 120° C. for 20 minutes so as to simultaneously cure both of the coating films, thereby obtaining a test plate.

The non-sand recoat adhesion of the resulting test plates were tested and evaluated according to the crosscut tape stripping test described in JIS K5400. The figures in the table indicate the number of cross-cuts (2×2 mm, total of 100 cross-cuts) that remained on the surface. The greater the figure (100 maximum), the better the adhesion properties would be.

The Tests (vi) to (viii) described below were conducted using the test plates prepared in the same manner as in the processes (1) to (3) in the aforesaid “Preparation of Coated Test Plates”. The test plates were subjected to a one-year outdoor exposure test in Okinoerabu Island. The coated plates were examined before and after exposure to evaluate the degree of deterioration (deterioration of film performance, i.e., the variance before and after exposure) of the coating films.

(vi) Change in Knoop Hardness Number (KHN);

After allowing the test plates to stand in a 20° C. constant-temperature room for 24 hours, the “Tukon hardness” (Knoop Hardness) was measured using a TUKON tester (produced by American Chain & Cable Company, micro hardness tester).

Tukon hardness, also called “Knoop Hardness Number (KHN)”, is a value expressing the hardness of a coating film, and is determined by pressing a square pyramidal diamond indenter with a specific load into the surface of a test material, and measuring the size of the diamond-shaped indentation in the surface. The greater the Tukon hardness value, the greater the hardness. The change in the hardness (KHN) was evaluated based on the following criteria, using the change in the Knoop Hardness (ΔKHN) before and after exposure as the indicator:

a: ΔKHN≦2,

c: 2<ΔKHN≦5,

e: 5<ΔKHN.

(vii) Change in scratch resistance:

In the same manner as in (i) of the above-described “Test Method”, the gloss retention (%) was measured before and after exposure. The change in the scratch resistance was evaluated based on the following criteria, using the change in the gloss retention (%)(ΔGR) before and after exposure as the indicator:

a: ΔGR≦5,

c: 5<ΔGR≦10,

e: 10<ΔGR.

(viii) Change in acid resistance:

In the same manner as in (ii) of the above-described “Test Method”, the depth of etching was measured before and after exposure. When no change was observed in the etching depth before and after exposure, the sample was evaluated as Excellent (a); and when any change was observed, the sample was evaluated as Defective (e).

(ix) Change in stain resistance:

Test plates prepared in the same manner as in (4) of the above-described “Preparation of Coated Test Plates” were used. These test plates were subjected to a one-year exposure test on Okinoerabu Island.

In the same manner as in (iv) of the above-described “Test Method”, the difference in lightness (ΔL) before and after exposure was calculated. When no reduction was observed in the difference in lightness (ΔL) before and after exposure, the sample was evaluated as Excellent (a); and when any reduction was observed, the sample was evaluated as Defective (e).

TABLE 3

| | | | Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| Coating Composition No. | | | 1 | 2 | 3 | 4 | 5 | 6 | 7 | 8 | 9 | 10 | 11 | 12 |
| A | Carboxy- | No. | A-1 | A-1 | A-1 | A-2 | A-3 | A-4 | A-1 | A-1 | A-1 | A-1 | A-1 | A-1 |
| | Containing | Resin Acid | 160 | 160 | 160 | 60 | 240 | 160 | 160 | 160 | 160 | 160 | 160 | 160 |
| | Polymer | Value | | | | | | | | | | | | |
| | | (mg KOH/g) | | | | | | | | | | | | |
| | | Amount (part) | 35 | 45 | 15 | 35 | 35 | 35 | 25 | 35 | 35 | 35 | 35 | 35 |
| B | Epoxy- | No. | B-1 | B-1 | B-1 | B-1 | B-1 | B-1 | B-2 | B-3 | B-4 | B-5 | B-1 | B-1 |
| | Containing | Amount (part) | 50 | 50 | 50 | 50 | 50 | 50 | 60 | 50 | 50 | 50 | 50 | 50 |
| | Acrylic Resin | | | | | | | | | | | | | |
| C | Carboxy- | No. | C-1 | C-1 | C-1 | C-1 | C-1 | C-1 | C-1 | C-1 | C-1 | C-1 | C-2 | C-3 |
| | Containing | Resin Acid | 112 | 112 | 112 | 112 | 112 | 112 | 112 | 112 | 112 | 112 | 68 | 198 |
| | Reaction | Value | | | | | | | | | | | | |
| | Product | (mg KOH/g) | | | | | | | | | | | | |
| | | Amount (part) | 15 | 5 | 35 | 15 | 15 | 15 | 15 | 15 | 15 | 15 | 15 | 15 |

| | | | | | | | | | | | | |
|---|---|---|---|---|---|---|---|---|---|---|---|---|
| Catalyst (*1) | 2 | 2 | 2 | 2 | 2 | 2 | 2 | 2 | 2 | 2 | 2 | 2 |
| UV1164 (*2) | 2 | 2 | 2 | 2 | 2 | 2 | 2 | 2 | 2 | 2 | 2 | 2 |
| HALS292 (*3) | 2 | 2 | 2 | 2 | 2 | 2 | 2 | 2 | 2 | 2 | 2 | 2 |
| BYK-300 (*4) | 0.2 | 0.2 | 0.2 | 0.2 | 0.2 | 0.2 | 0.2 | 0.2 | 0.2 | 0.2 | 0.2 | 0.2 |
| Equivalent Ratio of Acid/Epoxy | 1.2 | 1.3 | 1.1 | 0.6 | 1.7 | 1.2 | 1.7 | 0.6 | 1.2 | 1.22 | 1.1 | 1.2 |
| Scratch Resistance | 94 | 91 | 92 | 91 | 92 | 92 | 92 | 91 | 94 | 93 | 90 | 93 |
| Acid Resistance | 0.3 | 0.3 | 0.4 | 0.4 | 0.3 | 0.4 | 0.5 | 0.3 | 0.3 | 0.4 | 0.4 | 0.3 |
| 20° specular reflection | 86 | 84 | 88 | 88 | 84 | 88 | 87 | 83 | 86 | 85 | 87 | 86 |
| Stain Resistance | a | a | b | a | b | a | a | a | a | a | b | a |
| NSR | 100 | 100 | 100 | 100 | 100 | 100 | 100 | 100 | 100 | 100 | 100 | 100 |
| Before and After One-Year | | | | | | | | | | | | |
| Exposure in Okinoerabu | | | | | | | | | | | | |
| Change in Hardness (KHN) | a | a | a | a | a | a | a | a | a | a | a | a |
| Change in Scratch Resistance | a | a | a | a | a | a | a | a | a | a | a | a |
| Change in Acid Resistance | a | a | a | a | a | a | a | a | a | a | a | a |
| Change in Stain Resistance | a | a | a | a | a | a | a | a | a | a | a | a |

| | | | Examples | | | | | | Comparative Examples | | | | | | |
|---|---|---|---|---|---|---|---|---|---|---|---|---|---|---|---|
| | | | 13 | 14 | 15 | 16 | 17 | 18 | 1 | 2 | 3 | 4 | 5 | 6 | 7 |
| Coating Composition No. | | | 13 | 14 | 15 | 16 | 17 | 18 | 19 | 20 | 21 | 22 | 23 | 24 | 25 |
| A | Carboxy- | No. | A-1 | A-1 | A-1 | A-1 | A-1 | A-1 | A-1 | A-1 | A-1 | A-1 | A-1 | A-1 | A-1 |
| | Containing | Resin Acid | 160 | 160 | 160 | 160 | 160 | 160 | 160 | 160 | 160 | 160 | 160 | 160 | 160 |
| | Polymer | Value | | | | | | | | | | | | | |
| | | (mg KOH/g) | | | | | | | | | | | | | |
| | | Amount (part) | 35 | 35 | 35 | 35 | 25 | 45 | 35 | 35 | 35 | 35 | 35 | 45 | 35 |
| B | Epoxy- | No. | B-1 | B-1 | B-1 | B-1 | B-1 | B-1 | B-1 | B-1 | B-1 | B-1 | B-1 | B-1 | B-1 |
| | Containing | Amount (part) | 50 | 50 | 50 | 50 | 60 | 40 | 50 | 50 | 50 | 50 | 50 | 55 | 50 |
| | Acrylic Resin | | | | | | | | | | | | | | |
| C | Carboxy- | No. | C-4 | C-5 | C-6 | C-7 | C-1 | C-1 | C-8 | C-9 | C-10 | C-11 | C-12 | — | C-13 |
| | Containing | Resin Acid | 129 | 129 | 89 | 51 | 112 | 112 | 210 | 33 | 0 | 26 | 168 | — | 110 |
| | Reaction | Value | | | | | | | | | | | | | |
| | Product | (mg KOH/g) | | | | | | | | | | | | | |
| | | Amount (part) | 15 | 15 | 15 | 15 | 15 | 15 | 15 | 15 | 15 | 15 | 15 | — | 15 |

| | | | | | | | | | | | | | |
|---|---|---|---|---|---|---|---|---|---|---|---|---|---|
| Catalyst (*1) | 2 | 2 | 2 | 2 | 2 | 2 | 2 | 2 | 2 | 2 | 2 | 2 | 2 |
| UV1164 (*2) | 2 | 2 | 2 | 2 | 2 | 2 | 2 | 2 | 2 | 2 | 2 | 2 | 2 |
| HALS292 (*3) | 2 | 2 | 2 | 2 | 2 | 2 | 2 | 2 | 2 | 2 | 2 | 2 | 2 |
| BYK-300 (*4) | 0.2 | 0.2 | 0.2 | 0.2 | 0.2 | 0.2 | 0.2 | 0.2 | 0.2 | 0.2 | 0.2 | 0.2 | 0.2 |
| Equivalent Ratio of Acid/Epoxy | 1.3 | 1.3 | 1.2 | 1.1 | 0.8 | 1.9 | 1.5 | 1 | 0.9 | 1.01 | 1.36 | 1.11 | 1.19 |
| Scratch Resistance | 92 | 92 | 92 | 90 | 94 | 92 | 87 | 73 | 85 | 86 | 78 | 82 | 90 |
| Acid Resistance | 0.4 | 0.4 | 0.3 | 0.4 | 0.5 | 0.3 | 0.8 | 0.7 | 0.8 | 0.5 | 0.8 | 1.5 | 0.4 |
| 20° specular reflection | 86 | 85 | 87 | 85 | 85 | 87 | 84 | 83 | 86 | 86 | 84 | 84 | 90 |
| Stain Resistance | a | b | a | b | a | b | e | c | e | e | e | c | b |
| NSR | 100 | 100 | 100 | 100 | 100 | 100 | 72 | 54 | 60 | 38 | 69 | 46 | 28 |
| Before and After One-Year | | | | | | | | | | | | | |
| Exposure in Okinoerabu | | | | | | | | | | | | | |
| Change in Hardness (KHN) | a | a | a | a | a | a | c | a | a | a | c | e | c |
| Change in Scratch Resistance | a | a | a | a | a | a | a | c | a | c | a | c | c |
| Change in Acid Resistance | a | a | a | a | a | a | a | e | e | e | a | e | e |
| Change in Stain Resistance | a | a | a | a | a | a | a | a | e | a | a | e | e |

1. A coating composition comprising
(A) a carboxy-containing polymer,
(B) an epoxy-containing acrylic resin, and
(C) a carboxy-containing reaction product with an acid value of 50 to 200 mg KOH/g and a number average molecular weight of 600 to 5,000 obtained by a half-esterification reaction of an acid anhydride with a polycarbonate polyol having three or more hydroxyl groups per molecule.

2. The coating composition according to claim 1, wherein the acid anhydride is at least one kind selected from the group consisting of succinic anhydride, hexahydrophthalic anhydride, and trimellitic anhydride.

3. The coating composition according to claim 1, wherein the epoxy-containing acrylic resin (B) is an epoxy- and alkoxysilyl-containing acrylic resin.

4. The coating composition according to claim 1, wherein the proportions of the carboxy-containing polymer (A), epoxy-containing acrylic resin (B), and carboxy-containing reaction product (C) are such that the equivalent ratio of carboxy groups in the components (A) and (C) to epoxy groups in the component (B) is 1:0.5 to 0.5:1, and
the proportions of the carboxy-containing polymer (A) and carboxy-containing reaction (C) are such that, on a solids basis, the component (A) is 20 to 90 mass %, and the component (C) is 10 to 80 mass %, relative to the total amount of the components (A) and (C), and the proportion of the carboxy-containing reaction product (C) is, on a solids basis, 3 to 40 mass %, relative to the total amount of the carboxy-containing polymer (A), epoxy-containing acrylic resin (B), and reaction product (C).

5. A method for forming a multilayer coating film, the method comprising forming, on a substrate, one or two colored base coating layers and one or two clear coating layers, wherein an uppermost clear coating layer is formed using the coating composition according to claim 1.
